(19) United States
(12) Patent Application Publication
(10) Pub. No.: US 2026/0211295 A1
(43) Pub. Date: Jul. 23, 2026

(54) CAMERA MODULE

(71) Applicant: LG INNOTEK CO., LTD., Seoul (KR)

(72) Inventor: Sang Yeon HAN, Seoul (KR)

(21) Appl. No.: 19/141,660

(22) PCT Filed: Dec. 5, 2023
(86) PCT No.: PCT/KR2023/019929

§ 371 Date: Jun. 20, 2025

(30) Foreign Application Priority Data
Dec. 19, 2022 (KR) 10-2022-0178794

(51) Int. Cl. G03B 11/00; G03B 30/00

(52) U.S. Cl. CPC G03B 11/00; G03B 30/00

(57) ABSTRACT

A camera module according to one embodiment of the present invention comprises: a substrate; an image sensor disposed on the substrate; a plate disposed on the substrate; a base disposed on the plate; a lens barrel disposed on the base; a filter disposed on the plate; a first adhesive member disposed between the plate and the base; a second adhesive member disposed between the filter and the plate; a third adhesive member disposed on the edge of the filter, wherein the third adhesive member is disposed to encompass the upper surface and the outer side of the edge of the filter.

### TECHNICAL FIELD

The present invention relates to a camera module.

### BACKGROUND ART

Since it is difficult to apply the voice coil motor (VCM) technology used in existing conventional camera modules to ultra-small camera modules consuming low-power, research in this regard has been actively conducted.

In the case of a camera module being mounted on small electronic devices such as smartphones, the camera module may frequently receive impacts during use, and may shake slightly due to the user's handshaking or the like during photographing. In view of such a point, technologies to additionally install hand-shake prevention means in camera modules are being developed recently.

### DETAILED DESCRIPTION OF THE INVENTION

### Technical Subject

The technical problem to be solved by the present invention is to provide a miniaturized camera module.

### Technical Solution

In order to solve the above described technical problem, a camera module according to one embodiment of the present invention comprises: a substrate; an image sensor being disposed on the substrate; a plate being disposed on the substrate; a base being disposed on the plate; a lens barrel being disposed on the base; a filter being disposed on the plate; a first adhesive member being disposed between the plate and the base; a second adhesive member being disposed between the filter and the plate; a third adhesive member being disposed on the edge of the filter, wherein the third adhesive member is being disposed to encompass an upper surface and an outer side surface of the edge of the filter.

The third adhesive member can overlap the filter and the second adhesive member in an optical axis direction.

The third adhesive member is disposed to encompass an outer side surface of the second adhesive member, and the filter can be disposed between the second adhesive member and the third adhesive member.

The shrinkage rate of the second adhesive member may be smaller than the shrinkage rate of the third adhesive member.

The filter includes a hole, and a hole adhesive member can be disposed in the hole of the filter.

The plate includes an opening through which the image sensor passes, a first area in which the first adhesive member is disposed, and a second area in which the second adhesive member is disposed, wherein the first area and the second area can be disposed to be spaced apart from each other.

The plate may include a third region connecting the first area and the second area, wherein the opening may be formed to be larger than the image sensor.

The first area of the plate is formed to correspond to a lower surface of the base, and the second area of the plate may be formed to correspond to an edge of the filter.

The base includes an opening through which the lens barrel passes and an accommodating portion for accommodating the filter therein, wherein the filter can be disposed to be spaced apart inside the accommodating portion of the base.

In order to solve the above technical problem, a camera module according to an embodiment of the present invention comprises: a substrate; an image sensor being disposed on the substrate; a plate being disposed on the substrate; a lens driving device including a base being disposed on the plate, a housing being disposed on the base, and a bobbin being disposed inside the housing and movable in an optical axis direction; a lens barrel being disposed inside the bobbin; and a filter being disposed on the plate, wherein the plate includes a first area corresponding to a lower surface of the base and a second area corresponding to an edge of the filter, and wherein the filter is fixed to the plate by two adhesive members having different shrinkage rates.

The two adhesive members having different shrinkage rates include a second adhesive member being disposed between the filter and the plate and a third adhesive member being disposed at an edge of the filter, wherein the shrinkage rate of the second adhesive member may be smaller than the shrinkage rate of the third adhesive member.

The second adhesive member, the third adhesive member, and the filter can be overlapped with one another in an optical axis direction.

The filter includes a hole not being overlapped with the lens barrel in an optical axis direction, wherein a hole adhesive member can be disposed in the hole of the filter.

### Advantageous Effects

According to the present embodiments, the gap between an image sensor and a lens barrel can be reduced through a mold-less structure, so that a high CRA image sensor can be applied and the overall size of a camera module can be miniaturized.

In addition, by fixing the filter using two types of adhesives with different shrinkage rates, bending and damage to the filter can be prevented.

In addition, the gas being generated during an adhesive curing process can be discharged through a hole in a filter.

In addition, by arranging a reinforcing member on a substrate, bending of the substrate can be prevented even if impact occurs due to the operation of a lens barrel.

In addition, by arranging a damper member in a region where a lens barrel comes into contact when moving a lens barrel, impacts can be absorbed, preventing breakage of a filter and damage to a lens, thereby preventing a decrease in resolution.

In addition, by applying a cross air vent design to a damper member, a phenomenon in which a lens and a lens barrel are sticking to the damper member made of silicone material is prevented, and the attachment and detachment can be facilitated.

### BRIEF DESCRIPTION OF DRAWINGS

FIG. 1 is an exploded view of a camera module according to the present embodiment.

FIG. 2 is a perspective view of the camera module of FIG. 1.

FIG. 3a is an exploded view of a lens driving device according to one embodiment.

FIG. 3b is an exploded view of a lens driving device according to another embodiment.

FIG. 3c is an exploded view of a lens driving device according to yet another embodiment.

FIG. 3d is an exploded view of a lens driving device according to still yet another embodiment.

FIG. 4a is a cross-sectional view of an area where an image sensor and a filter are disposed according to the present embodiment.

FIG. 4b is a cross-sectional view of an area where an image sensor and a filter are disposed according to another embodiment of the present invention.

FIG. 5 is a drawing for explaining the disposement of a filter and a lens barrel according to the present embodiment.

FIG. 6 is a drawing illustrating a plate according to another embodiment of the present invention.

FIG. 7 is a drawing illustrating a plate according to yet another embodiment of the present invention.

FIG. 8 is a perspective view of a portable terminal according to the present embodiment.

FIG. 9 is a configuration diagram of the portable terminal illustrated in FIG. 8.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected', 'coupled’ or ‘interconnected’ to another component, the component is not only directly connected, coupled or interconnected to the other component, but may also include cases of being ‘connected', 'coupled', or 'interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

Hereinafter, a camera module according to an embodiment and an optical device including the same will be described as follows with reference to the attached drawings. For convenience of explanation, the camera module according to the embodiment will be described using a Cartesian coordinate system (x, y, z), but may be described using another coordinate system, and the embodiment is not limited thereto. In each drawing, an x-axis and a y-axis represent directions perpendicular to a z-axis, which is an optical axis (OA) direction, and a z-axis direction, which is the optical axis (OA) direction, may be referred to as a ‘first direction’, an x-axis direction may be referred to as a ‘second direction’, and a y-axis direction may be referred to as a ‘third direction’.

The handshake correction function’ applied to a camera module of a mobile device such as a smartphone or tablet PC may be a function that moves the lens in a direction perpendicular to the optical axis direction or tilts the lens with respect to the optical axis to offset vibration (or movement) caused by the user's hand shaking.

In addition, an ‘auto focusing function’ may be a function that automatically focuses on a subject by moving a lens in an optical axis direction according to a distance to the subject to obtain a clear image of the subject on an image sensor.

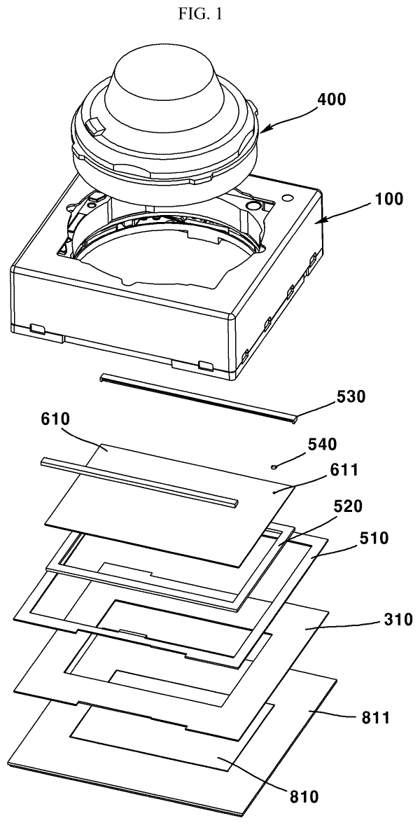

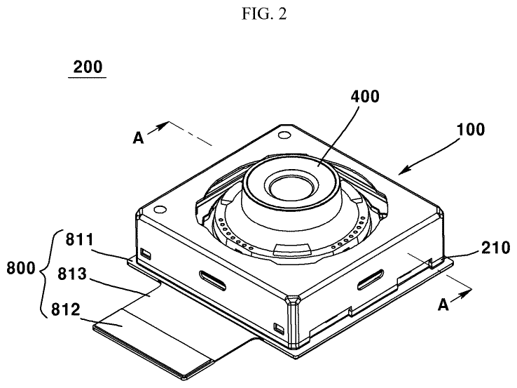

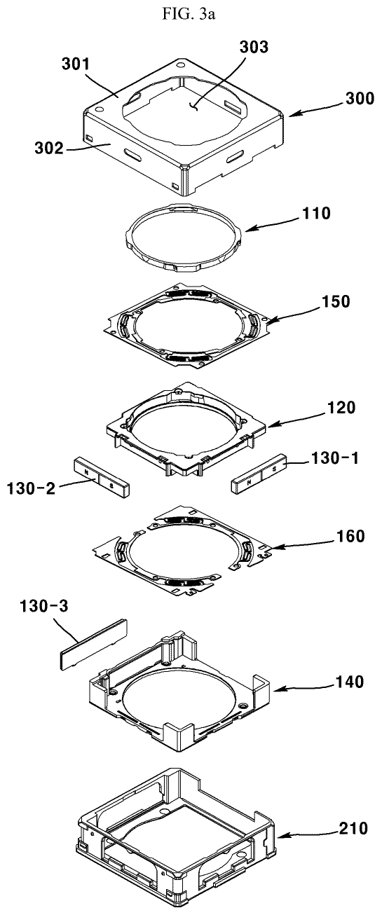

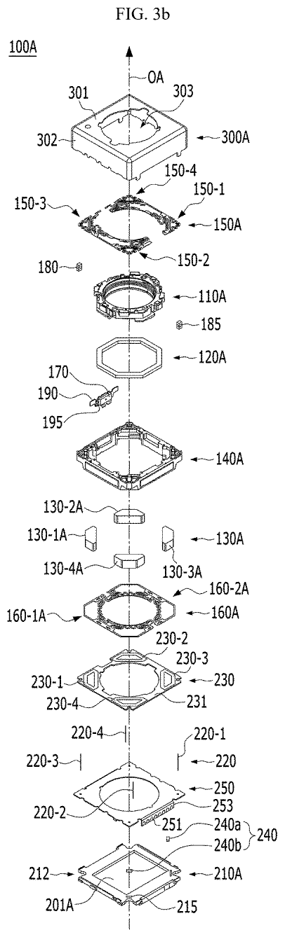

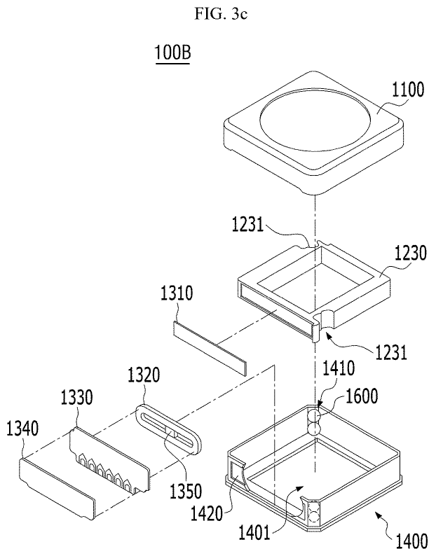

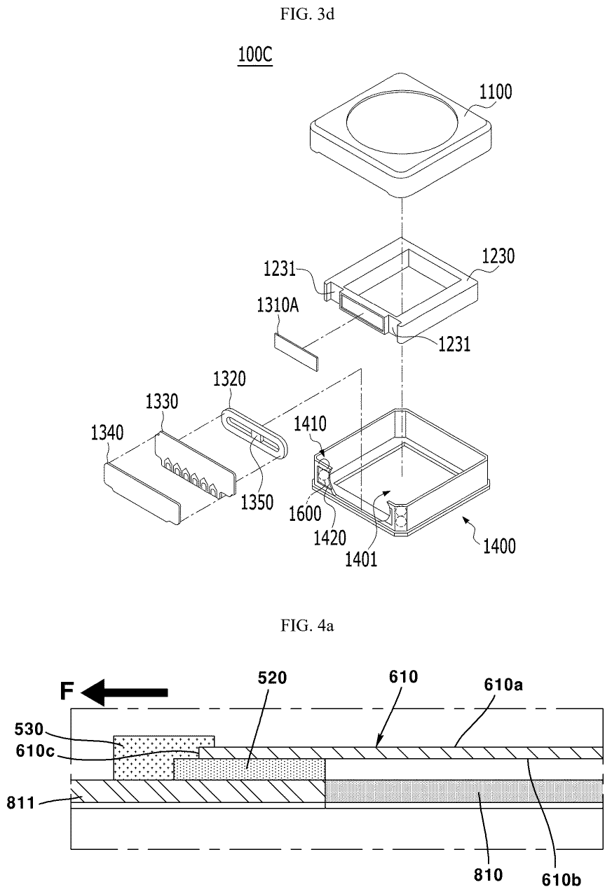

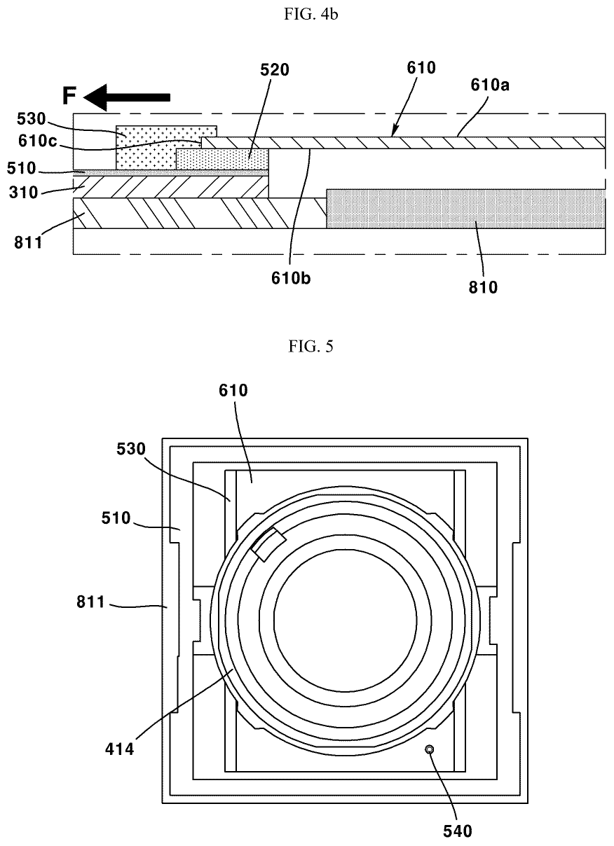

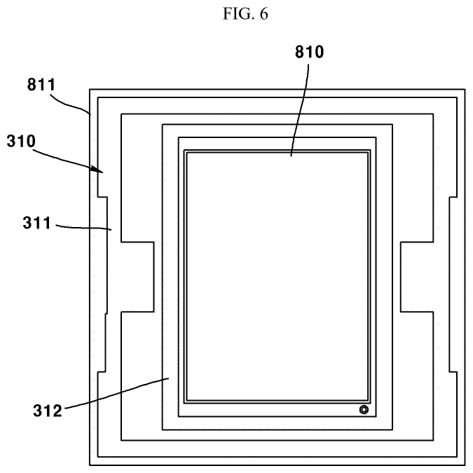

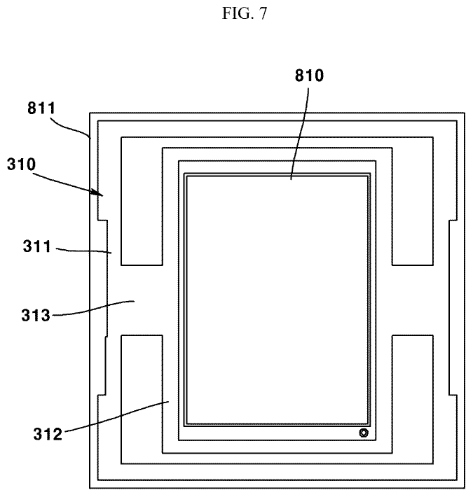

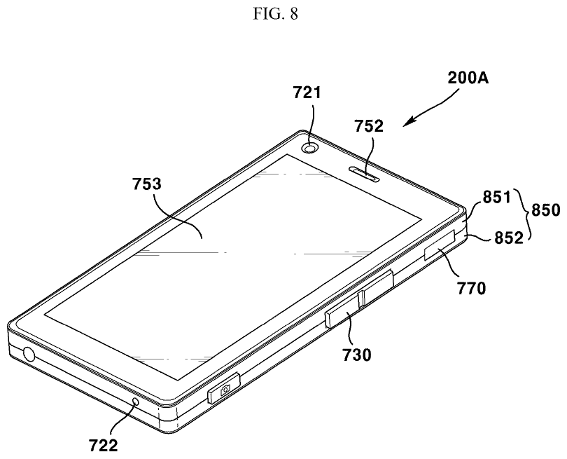

FIG. 1 is an exploded view of a camera module according to the present embodiment; FIG. 2 is a perspective view of the camera module of FIG. 1; FIG. 3a is an exploded view of a lens driving device according to one embodiment; FIG. 3b is an exploded view of a lens driving device according to another embodiment; FIG. 3c is an exploded view of a lens driving device according to yet another embodiment; FIG. 3d is an exploded view of a lens driving device according to still yet another embodiment; FIG. 4a is a cross-sectional view of an area where an image sensor and a filter are disposed according to the present embodiment; FIG. 4b is a cross-sectional view of an area where an image sensor and a filter are disposed according to another embodiment of the present invention; FIG. 5 is a drawing for explaining the disposement of a filter and a lens barrel according to the present embodiment; FIG. 6 is a drawing illustrating a plate according to another embodiment of the present invention; FIG. 7 is a drawing illustrating a plate according to yet another embodiment of the present invention; and FIG. 8 is a perspective view of a portable terminal according to the present embodiment.

The camera module 200 may include a lens module 400, a lens driving device 100, a filter 610, a holder 310, a circuit board 800, and an image sensor 810.

The camera module 200 can photograph at least one of an image and a video. The camera module 200 may be a camera assembly. The camera module 200 may be a camera unit. The camera module 200 may include a lens driving device 100. The lens driving device 100 may drive the lens module 400 and move the lens module 400 in an optical axis direction. The lens module 400 may be referred to as a “lens,” “lens unit,” or “lens assembly.” The lens module 400 is coupled with the lens driving device 100 and may include at least one of a lens unit or a lens barrel.

The camera module 200 may include a sensor driving device. The camera module 200 may include a voice coil motor (VCM). The camera module 200 may include an auto focus assembly. The camera module 200 may include a handshake correction assembly. The camera module 200 may include an auto focus device. The camera module 200 may include a handshake correction device. The camera module 200 may include an actuator. The camera module 200 may include a lens driving actuator. The camera module 200 may include a sensor driving actuator. The camera module 200 may include an auto focus actuator. The camera module 200 may include a handshake correction actuator.

The camera module 200 may include a circuit board 800. The circuit board 800 may be a main board. The circuit board 800 may be a printed circuit board (PCB). The circuit board 800 may be connected to a power source of the optical device. The circuit board 800 may include a connector being connected to a power source of an optical device. The circuit board 800 may have circuit elements 95 (or electronic elements) being disposed thereon. An adhesive member may be included for coupling or attaching the lens driving device 100 and the circuit board 810.

The camera module 200 may include a base 210. The base 210 may be disposed in the circuit board 800. The base 210 may be disposed on the circuit board 800. The base 210 may be disposed above the circuit board 800. The base 210 may be fixed to the circuit board 800. The base 210 may be coupled to the circuit board 800. The base 210 may be attached to the circuit board 800 by an adhesive member 612.

The camera module 200 may include an image sensor 810. The image sensor 810 may be disposed in the circuit board 800. The image sensor 810 may be disposed between the circuit board 800 and the base 210. The image sensor 810 may be electrically connected to the circuit board 800. The image sensor 810 may be disposed below the lens module 16.

Light passing through the lens module 400 and the filter 610 may be incident on the image sensor 810 to form an image. The image sensor 810 may include an effective image area. The image sensor 810 may convert light irradiated to the effective image area into an electrical signal. The image sensor 810 may include at least one of a charge-coupled device (CCD), a metal oxide semiconductor (MOS), a CPD, and a CID.

The camera module 200 may include a filter 610. The filter 610 may be disposed between the lens module 400 and the image sensor 810. The filter 610 may be disposed in the holder 310. The filter 610 may be disposed in the window 318 of the holder 310. The filter 610 may block light of a specific frequency band from being incident on the image sensor 810. The filter 610 may include an infrared cut-off filter (IRCF). The filter 610 may block infrared rays from being incident on the image sensor 810.

The lens driving device 100 illustrated in FIG. 3A is a lens driving device for AF, but embodiments are not limited thereto. In another embodiment, the lens driving device may be a lens driving device for OIS. Here, the meanings of “for AF” and “for OIS” may be the same as those described in the camera module for AF and the camera module for OIS.

Also, in FIG. 3a, the bobbin and the housing are supported by an elastic member, but are not limited thereto, and in other embodiments, they may be supported by a ball or a ball bearing.

Referring to FIG. 3a, a lens driving device 100 may comprise a housing 140, a bobbin 120 for mounting the lens module 400, a coil 110 being mounted in the bobbin 120, a magnet 130 being disposed inside the housing 140 and facing the coil 110, at least one upper elastic member 150 being coupled to an upper portion of the bobbin 120 and an upper portion of the housing 140, at least one lower elastic member 160 being coupled to a lower portion of the bobbin 120 and a lower portion of the housing 140, and a base 210. In another embodiment, the coil is disposed in the housing, and the magnet may be disposed in the bobbin.

The lens driving device 100 may further include a cover member 300 being coupled to the base 210 and for providing a space for accommodating components of the lens driving device 100 together with the base 210. The cover member 300 may be a ‘cover can’ or a ‘shield can’. The cover member may be formed of a metal material. The cover member 300 may block electromagnetic interference (EMI). The cover member 300 may be electrically connected to the circuit board 800. The cover member 300 may be grounded to the circuit board 800. The cover member 300 may include an upper plate 301, a side plate 302 being connected to the upper plate 301, and an opening 303 being formed in the upper plate 301.

The base 210 is disposed below the bobbin 120 (or the housing 140). The housing 140 may be disposed on the base 210. The base 210 may be coupled to the housing 140. In another embodiment, the base 210 and the housing 140 may be integrally configured, and such a configuration may be defined as a “base” or a “housing”.

The base 210 may have an opening 201 corresponding to the opening of the bobbin 120 and/or the opening of the housing 140, and may have a shape that matches or corresponds to the cover member 300, for example, a square shape. The opening 201 of the base 210 may have a shape of a through hole penetrating the base 210 in an optical axis direction. A pillar portion being protruded toward the housing 140 may be formed on an upper surface of the base 210.

The base 210 may include a pillar portion protruded upwardly from a corner or each of the corners by a predetermined height. For example, the base 210 may include four pillar portions being disposed at four corners. In another embodiment, the pillar portion may be omitted. The pillar portion of the base 210 may be inserted into, fastened to, or coupled to a groove formed at a lower portion of the corner of the housing 140 by an adhesive material such as an epoxy or a silicone.

The coil 110 may be connected to at least one of the upper elastic member 150 and the lower elastic member 160. The lower elastic member 160 may include two lower elastic members and lower springs. The coil 110 may be connected to two lower elastic members.

The upper elastic member 150 may include a first inner frame (or a first inner side portion) being coupled to the bobbin 120, a first outer frame (or a first outer side portion) being coupled to the housing 140, and a first connection unit connecting the first inner frame and the first outer frame. The lower elastic member may include a second inner frame (or a second inner side portion) being coupled to the bobbin 120, a second outer frame (or a second outer side portion) being coupled to the housing 140, and a second connection unit connecting the second inner frame and the second outer frame. One end of the coil 110 may be connected to the second inner frame of the first lower elastic member, and the other end of the coil 110 may be connected to the second inner frame of the second lower elastic member.

The first lower elastic member may include a first terminal, and the second lower elastic member may include a second terminal. The driving signal of the coil 110 may be inputted from the outside through the first and second terminals of the first and second lower elastic members.

The first terminal may be bent from a second outer frame of the first lower elastic member to an outer side surface (or “first outer side surface”) of the base 210. The second terminal may be bent from a second outer frame of the second lower elastic member to an outer side surface (or “first outer side surface”) of the base 210. At least a portion of each of the first and second terminals may be extended to an outer side surface of the holder 310 and may be electrically connected to the circuit board 800.

The circuit board 800 may provide a driving signal to the coil 110 through the first and second terminals of the first and second lower elastic members, and may include pads (or terminals) being electrically connected to the first and second terminals through a solder or the like.

In other embodiments, the terminal may not be formed integrally with a lower elastic member, but may be disposed separately in the base 210, and a terminal and an outer frame of the lower elastic member may be coupled and electrically connected by a solder or the like.

The coil 110 may be disposed on an outer side surface of the bobbin 120. For example, the coil 110 may be wound in a ring shape on an outer side surface of the bobbin 120, but is not limited thereto. A driving signal may be provided to the coil 110. The driving signal may be in the form of a current or a voltage, and may include at least one of a direct current signal or an alternating current signal.

The magnet 130 may be disposed at a side portion of the housing 140. In another embodiment, the magnet may be disposed at a corner or a corner of the housing. The magnet 130 may include a plurality of magnets 130-1 to 130-3, and the magnet 130 disposed at the housing 140 may correspond to, face, or overlap the coil 110 in a direction perpendicular to the optical axis OA.

The moving part may be moved in an optical axis direction by the interaction between the magnet 130 and the coil 110 provided with the driving signal. By controlling the displacement of the bobbin 120 in an optical axis direction by the driving signal being provided to the coil 110, AF driving may be implemented.

The moving part may include a bobbin 120 and a configuration coupled thereto. For example, the moving part may include a bobbin 120 and a coil 110. Also, for example, the moving part may further include a lens module 400.

For AF feedback driving, the lens driving device 100 of the camera module 200 may further include a sensing magnet (not shown) being disposed in the bobbin, and an AF position sensor (for example, a hall sensor, not shown) being disposed on the housing, the base, or the cover member and corresponding to, facing, or being overlapped with the sensing magnet. The lens driving device 100 may further include an AF circuit board being disposed in the housing 140 and on which the AF position sensor is mounted. In this case, the circuit board may be electrically connected to the coil 110 and the AF position sensor, and a driving signal may be provided to each of the coil 110 and the AF position sensor through the circuit board.

When the AF position sensor is implemented using only a Hall sensor, a driving signal may be provided from the outside to the circuit board, and the driving signal may be provided to the coil 110 through the circuit board and two elastic members connected to the circuit board.

When the AF position sensor is a driver IC including a Hall sensor, a driving signal may be provided from the AF position sensor to the circuit board, and the driving signal may be provided to the coil 110 through two elastic members connected to the circuit board.

The AF position sensor can output an output signal according to the result of detecting the strength of the magnetic field of the sensing magnet due to the movement of the bobbin 120, and the output of the AF position sensor can be transmitted to a circuit board and outputted to the outside through the circuit board.

In another embodiment, the AF position sensor may be disposed in the bobbin and the sensing magnet may be disposed in the housing. In addition, the lens driving device 100 may further include a balancing magnet being disposed in the bobbin 120 and disposed at an opposite side of the sensing magnet.

A camera module according to another embodiment may be coupled with a lens module 400 instead of the lens driving device 100 of FIG. 1, and may include a housing for fixing the lens module 400, and the housing may be coupled or attached to an upper surface of the circuit board 800.

The housing attached or fixed to an upper surface of the circuit board 800 does not move, and the position of the housing and the lens module coupled to the housing may be fixed while attached to the circuit board 800.

The lens driving device 100A illustrated in FIG. 3b may be a lens driving device for OIS.

Referring to FIG. 3B, a lens driving device 100A may include a housing 140A, a bobbin 120A being disposed inside the housing 140A for mounting the lens module 400, a first coil 110A being disposed in the bobbin 120A, a magnet 130A being disposed in the housing 140A and facing the first coil 110A, at least one upper elastic member 150A being coupled to a lower portion of the bobbin 120A and a lower portion of the housing 140A, at least one lower elastic member 160A coupled to a lower portion of the bobbin 120A and a lower portion of the housing 140A, a second coil 230 disposed below the housing 140A, a circuit board 250 being disposed below the second coil 230, and a base 210 being disposed below the circuit board 250.

The lens driving device 100A may include a support member 220 connecting the upper elastic member 150A and the circuit board 250. The lens driving device 100A may include a sensing magnet 180 being disposed in the bobbin 120A and a first position sensor 170 being disposed in the housing 140. The lens driving device 100A may include a balancing magnet 185 being disposed in the bobbin 120A.

The description of the bobbin 110, the coil 120, the magnet 130, the housing 140, the AF position sensor, the sensing magnet, and the balancing magnet of FIG. 3a may be applied to the embodiment of FIG. 3b.

The lens driving device 100A may include the circuit board 190 being disposed in the housing 140A, and the circuit board 190 may be disposed in one side portion of the housing 140A. The first position sensor 170 may be disposed in the circuit board 190 and may be electrically connected to the circuit board 190. In addition, the description of the AF position sensor and the circuit board of FIG. 3a may be applied to the embodiment of FIG. 3b.

In addition, the lens driving device may further include a capacitor 195 being disposed in the circuit board 190. The capacitor 195 may be connected in parallel to two input terminals of the first position sensor 170 for providing a power or a driving signal, or two terminals of the circuit board 190 being electrically connected to two input terminals of the first position sensor 170. The capacitor 195 may protect the first position sensor 170 from noise or ESD of a high frequency component introduced from the outside.

The upper elastic member 150A may include a plurality of upper elastic members 150-1 to 150-4. A plurality of elastic members may be electrically connected to the circuit board 190. For example, the four upper elastic members 150-1 to 150-4 may be coupled and electrically connected to corresponding one of the first to fourth terminals of the circuit board 190.

The first position sensor 170 may be implemented as a Hall sensor alone or may be in the form of a driver IC including a Hall sensor. The first position sensor 170 may include four terminals, and the four terminals of the first position sensor may be electrically connected to the first to fourth terminals of the circuit board 190.

The magnet 130A may include a plurality of magnets 130-1A to 130-4A disposed at corners of the housing 140A, but is not limited thereto, and in other embodiments, the magnet may be disposed at a side portion of the housing 140A as shown in FIG. 3a.

The supporting member 220 may include a plurality of supporting members 220-1 to 220-4. The supporting members 220-1 to 220-4 may be disposed in corners or corners of the housing 140A. A corner of the housing 140 may be formed in a groove or a hole for avoiding spatial interference with the supporting member 220, and the supporting member 200 may pass through the groove or the hole.

One end of each of a plurality of support members 220-1 to 220-4 may be coupled to and electrically connected to a corresponding one of a plurality of upper elastic members 150-1 to 150-4. One end of each of a plurality of support members 220-1 to 220-4 may be coupled to and electrically connected to the circuit board 250 or the circuit member 231.

The circuit board 190 may be electrically connected to the circuit board 250 by a plurality of upper elastic members 150-1 to 150-4 and support members 220-1 to 220-4, and thus the first position sensor 170 may be electrically connected to the circuit board 250.

The lower elastic member 160 may include two lower elastic members 160-1A and 160-2A, and may be electrically connected to the first coil 110A. The first coil 110A may be electrically connected to the circuit board 250 or the first position sensor 170. A driving signal may be supplied or transmitted to the first coil 120 from the first position sensor 170 or the circuit board 250.

The second coil 230 may be aligned under the bobbin 120A and/or the housing 140A. For example, the second coil 230 may be aligned below the magnet 130A. The second coil 230 may include coil units 230-1 to 230-4 facing the magnets 130-1A to 130-4A and being overlapped with the housing 140A in an optical axis direction.

For example, the second coil 230 may include a circuit member 231 aligned on the circuit board 250 and a plurality of coil units 230-1 to 230-4 formed in the circuit member 231. Here, the circuit member 231 may be expressed as a “substrate,” a “circuit board,” a “coil board” or the like. In another embodiment, the circuit member 231 may be omitted from the second coil 230 and may include coil units 230-1 to 230-4. The second coil 230 may be electrically connected to the circuit board 250 and may receive a power source or a driving signal from the circuit board 250.

By the interaction between the magnets 130-1A to 130-4A and the second coils 230-1 to 230-4 provided with the driving signal, the housing 140A may move in a second direction and/or a third direction, for example, in an X-axis direction and/or a Y-axis direction, thereby performing handshake correction.

The circuit board 250 is aligned on an upper surface of the base 210A, and may include an opening corresponding to the opening of the bobbin 120A, the opening of the housing 140A, or/and the opening 201A of the base 210. The opening of the circuit board 250 may be a through hole or a hollow.

The circuit board 250 may include a body being disposed to a top surface of the base 210A and having an opening, and at least one terminal surface 253 being bent from the body to an outer side surface of the base 210A. A plurality of terminals 251 for receiving electrical signals from the outside or transmitting electrical signals to the outside may be formed in the terminal surface 253 of the circuit board 250. A plurality of terminals 251 of the circuit board 250 may be electrically connected to at least one of the first coil 120, the first position sensor 170, the circuit board 190, the second position sensor 240, and the second coil 230.

The base 210A may include an opening 201A. The description of the base 210 in the embodiment of FIG. 3a may be applied to FIG. 3b. In another embodiment, the base 210A and the housing 140A may be integrally formed, and such a configuration may be defined as a “base” or a “housing”. To avoid spatial interference with the support member 220, a cover part 212 having a groove, a concave groove, or a hole shape may be formed at a corner of the base 210A.

The lens driving apparatus 100A may further include a second position sensor 240 being electrically connected to the circuit board 250. The second position sensor 240 may include two sensors 240a and 240b, and may be electrically connected to the circuit board 250. Each of the two sensors 240a and 240b may be implemented by a position detection sensor such as a Hall sensor or the like, or may be implemented in the form of a driver including a Hall sensor. The base 210A may include a groove 215 for accommodating the sensors 240a and 240b.

Each of the sensors 240a and 240b may detect the strength of magnetic fields of the magnets 130-1A to 130-4A due to the movement of the housing 140 in a direction perpendicular to the optical axis, and output an output signal according to a detected result. Displacement in a direction perpendicular to the optical axis of the housing 140A may be detected by using output signals of each of the sensors 240a and 240b, and the control units 830 and 780 may perform OIS feedback handshake correction by using output signals of the sensors 240a and 240b.

The lens driving device 100B illustrated in FIG. 3c may be a ball-type lens driving device.

Referring to FIG. 3c, the lens driving device 100B may comprise a housing 1400, a bobbin 1230 being disposed inside the housing 1400 and coupled with the lens module 400, a coil 1320 being disposed inside the housing 1400 and a magnet 1310 being disposed in the bobbin 1230, a ball 1600 being disposed between the housing 1400 and the bobbin 1230, and a yoke 1340 being disposed in the housing 1400. The ball 1600 may also be expressed as a “ball member” or a “ball bearing”.

The lens driving device 100B may include a cover member 1100 coupled with the housing 1400 to encompass an outer side surface of the housing 1400. The lens driving device 100B may include a position sensor 1350 being disposed in the housing 1400. In addition, the lens driving device 100B may include a circuit board 1330 being disposed in the housing 1400, and the position sensor 1350 may be mounted on the circuit board 1330 and may be electrically connected to the circuit board 1330. The description of the position sensor of FIGS. 3a and 3b may be applied to the position sensor 1350 of FIG. 3c.

The bobbin 1230 may have an opening for being coupled with a lens module; and the opening of the bobbin 1230 may be in the form of a through hole penetrating the bobbin in an optical axis direction. The magnet 1310 may be disposed on an outer side surface of the bobbin 1230. A groove may be formed on an outer side surface of the bobbin 1230 for arranging the magnet 1310.

The coil 1320 may be disposed on any one side portion 1420 of the housing 1400 facing the magnet 1310. For example, a groove may be formed on any one side portion of the housing 1400 for arranging the magnet 1310. In another embodiment, the magnet may be disposed in the housing and the coil may be disposed in the bobbin.

The housing 1400 may have an opening 1401 corresponding to the lens module 400, and the opening 1401 of the housing 140 may be in the form of a through hole penetrating the housing 1400 in an optical axis direction.

The coil 1320 can be electrically connected to the circuit board 1330.

The ball 1600 can support the bobbin 1230 for moving relative against the housing 1400. At least a portion of the ball 1600 can be in contact with at least a portion of the housing 1400 and at least a portion of the bobbin 1230, thereby reducing friction between the housing 1400 and the bobbin 1230.

The yoke 1340 may be disposed on one side portion of the housing 1400 and may face the magnet 1310 in a direction perpendicular to the optical axis. For example, the yoke 1340 may be disposed at an outside of the circuit board 1330, and a coil 1320 may be disposed between the yoke 1340 and the magnet 1310.

The yoke 1340 may be made of a material capable of generating an attractive force between it and the magnet 1310, such as a magnet or metal, and accordingly, an attractive force may act between the yoke 1340 and the magnet 1310 in a direction perpendicular to the optical axis. By this attractive force, the ball 1600 can maintain the contact with the bobbin 1230 and the housing 1400.

The housing 1400 may be formed with a first accommodating groove 1410 for accommodating at least a portion of the ball 1600 or for arranging at least a portion of the ball 1600. The bobbin 1230 may be formed with a second accommodating groove 1231 for accommodating at least another portion of the ball 1600 or for arranging at least another portion of the ball 1600.

The first accommodating groove 1410 may be formed at an inner side or inner surface of at least one corner of the housing 1400, and the second accommodating groove 1231 may be formed at an outer side or outer surface of at least one corner of the bobbin 1230. The first accommodating groove 1410 and the second accommodating groove 1231 may face or oppose each other, and the ball 1600 may be disposed between the first accommodating groove 1410 and the second accommodating groove 1231 and may come into contact with each of the first accommodating groove 1410 and the second accommodating groove 1231. The number of balls 1600 being disposed between the first accommodating groove 1410 and the second accommodating groove 1231 may be one or more.

In FIG. 3c, a first accommodating groove may be formed at each of two corners of the housing 1400 being disposed to face or oppose each other, and a second accommodating groove may be formed at each of two corners of the bobbin 1230 corresponding to the two corners of the housing 140.

In another embodiment, a first accommodating groove may be formed at each of the four corners of the housing 1400, and a second accommodating groove may be formed at each of the four corners of the bobbin 1230 corresponding to the four corners of the housing 140.

In another embodiment, a first accommodating groove may be formed at each of two corners of the housing 1400 adjacent to the side portion 1420 of the housing 1400 in which the coil 1320 and/or the circuit board 1330 are disposed.

Additionally, a second accommodating groove may be formed at each of two corners of the bobbin 1230 corresponding to two corners of the two housings 1400 adjacent to the side portion 1420 of the housing 1400.

In another embodiment, a first accommodating groove may be formed at each of two corners adjacent to a side portion positioned at an opposite side portion 1420 of the housing 1400. A second accommodating groove may be formed at each of two corners of the bobbin 1230 corresponding to the two corners adjacent to a side portion positioned at an opposite side portion 1420 of the housing 1400.

As shown in FIG. 3c, the housing 1400 may be implemented as a single body, but is not limited thereto. In another embodiment, the housing 1400 may include a housing and a base being coupled to the housing, as in FIG. 3a and FIG. 3b. At this time, the base may have an opening that is the same as or similar to the opening 1401 of the housing 1400.

For the convenience of the following description, the base 210 of the lens driving device 100 is described as an example, but is not limited thereto. The following description can also be applied or analogically applied to the base 210A of the lens driving device 100A and the housing 1400 of the lens driving device 100B.

FIG. 3d may be a lens driving device 100C that is a modified embodiment of FIG. 3c.

In FIG. 3d, the ball 1600 can be disposed between two corners adjacent to the side portion 1420 of the housing 1400 in which the coil 1320 and/or the circuit board 1330 are disposed and the corresponding outer side surface of the bobbin 1230.

For example, in FIG. 3d, the first accommodating groove 1410 may be formed at each of two corners of the housing 1400 adjacent to the side portion 1420 of the housing 1400 where the coil 1320 and/or the circuit board 1330 are disposed, and the second accommodating groove 1231 may be formed at corners of the bobbin 1230 corresponding to the two corners of the housing 1400.

The magnet 1310A can be disposed between balls 1600 accommodated in second accommodating grooves 1231 formed at two corners of the bobbin 1230. For example, the magnet 1310A can be disposed between two second accommodating grooves 1231 formed at two corners of the bobbin 1230.

FIG. 4a is a cross-sectional view of an area where an image sensor and a filter are disposed according to the present embodiment; FIG. 4b is a cross-sectional view of an area where an image sensor and a filter are disposed according to another embodiment of the present invention; FIG. 5 is a drawing for explaining the disposement of a filter and a lens barrel according to the present embodiment; FIG. 6 is a drawing illustrating a plate according to another embodiment of the present invention; and FIG. 7 is a drawing illustrating a plate according to yet another embodiment of the present invention.

According to the embodiment of the present invention illustrated in FIG. 4a, the filter 610 may be disposed on the substrate 811. The second adhesive member 520 may be disposed between the filter 610 and the substrate 811. The second adhesive member 520 may fix the filter 610 on the substrate 811. The second adhesive member 520 may be disposed at the edge of the opening of the substrate 811. The second adhesive member 520 may be disposed corresponding to the edge of the filter 610. The second adhesive member 520 may be disposed on a lower surface 610b of the filter 610.

A filter 610 may be disposed on a second adhesive member 520 and a third adhesive member 530 may be disposed at an edge of the filter 610. The third adhesive member 530 may be disposed at the edge of the filter 610. The third adhesive member 530 may be disposed to encompass an upper surface and an outer side surface of the edge of the filter 610. The third adhesive member 530 may be disposed at two opposite surfaces of the edge of the filter 610. The third adhesive member 530 may be disposed at four surfaces of the edge of the filter 610. The third adhesive member 530 may be disposed to encompass an outer side surface of the second adhesive member 520. The second adhesive member 520 and the third adhesive member 530 may be disposed to form a step.

The filter 610 may include an upper surface 610a, a lower surface 610b being disposed at an opposite side of the upper surface 610a, and a side surface 610c connecting the upper surface 610a and the lower surface 610b. The upper surface 610a, the lower surface 610b, and the side surface 610c of the filter 610 may be in contact with an adhesive member. A portion of the upper surface 610a, a portion of the lower surface 610b, and a portion of the side surface 610c of the filter 610 may be in contact with the adhesive member. The lower surface 610b of the filter 610 may be in contact with the second adhesive member 520. The upper surface 610a of the filter 610 may be in contact with the third adhesive member 530. The side surface 610c of the filter 610 can be in contact with at least one of the second adhesive member 520 and the third adhesive member 530. The third adhesive member 530 can be in contact with the upper surface 610a and the side surface 610c of the filter 610 and the upper surface and the side surface of the second adhesive member 520.

The second adhesive member 520 and the third adhesive member 530 may be an epoxy being cured by UV. The second adhesive member 520 and the third adhesive member 530 may have different shrinkage rates. The shrinkage rate of the second adhesive member 520 may be lower than the shrinkage rate of the third adhesive member 530. For example, the shrinkage rate of the second adhesive member 520 may be about 2% to 3%, and the shrinkage rate of the third adhesive member 530 may be 5 to 10% or more.

In order to fix the filter 610 to the substrate 811, a second adhesive member 520 is first applied to the substrate 811, and then the filter 610 is placed. Thereafter, a third adhesive member 530 is secondarily applied to the edge of the filter 610 and cured. Since the third adhesive member 530 has a larger shrinkage rate than the second adhesive member 520, the third adhesive member 530 can provide tension F to the filter 610. Since shrinkage occurs during the curing process of the third adhesive member 530, tension F that pulls the filter 610 is generated, so that wave occurrence in the filter 610 can be minimized. The second adhesive member 520 can serve to support the filter 610, and the third adhesive member 530 can serve to prevent bending by generating tension in the filter 610. The second adhesive member 520 and the third adhesive member 530 can serve to fix the filter 610 in two stages.

A portion of the third adhesive member 530 being disposed in the filter 610 may be overlapped with a lens barrel in an optical axis direction. A portion of the third adhesive member 530 may face a lower surface of the lens barrel. In order to prevent the lens barrel and the filter 610 from coming into contact when the lens barrel moves in an optical axis direction, the third adhesive member 530 may be disposed higher than the filter 610. When the lens barrel moves in an optical axis direction, the lens barrel may first come into contact with the third adhesive member 530 than the filter 610.

Referring to FIG. 4b, the plate 310 may be disposed on an upper surface of the substrate 811. The base 210 may be disposed on an upper surface of the plate 310. The plate 310 may be disposed at an inner side of the base 210. A first adhesive member 510 may be disposed between the plate 310 and the base 210. The first adhesive member 510 may fix the base 210 on the plate 310. The first adhesive member 510 may be applied on the plate 310 corresponding to a lower surface of the base 210.

The plate 310 may include an opening through which the image sensor 810 passes. The opening of the plate 310 may be formed to be larger than the image sensor 810. The plate 310 may include an opening and may be formed to have a size corresponding to the substrate 811. The plate 310 may be formed of a reinforcing member. The plate 310 may be formed of a material having a strong force that resists external force. For example, the plate 310 may be formed of a metal frame made of a metal for example, stainless steel, aluminum, copper, or the like.

The filter 610 according to the present embodiment described below has a structure being disposed by an adhesive without a separate support structure, so the area supporting the filter 610 is reduced, which may make it vulnerable to impact. As an image sensor with an increasing chief ray angle (CRA) is applied, the FBL length of the lens is becoming shorter. Accordingly, warping of the substrate may occur due to an impact caused by movement of the lens barrel in an optical axis or movement of the camera module, and the filter may warp more due to the warping of the substrate. Accordingly, a problem of contact between the filter and the image sensor may occur, so it is necessary to minimize the warping of the substrate. By arranging a plate 310, which is a reinforcing member, on the substrate 811 according to the present embodiment, the warping of the substrate 811 can be minimized.

Another embodiment, the plate 310 illustrated in FIG. 6, may include an opening through which an image sensor 810 passes, a first area 311 in which a first adhesive member 510 is disposed, and a second area 312 in which a second adhesive member 520 is disposed. A base 210 may be disposed on the first area 311. The first area 311 may be formed corresponding to an edge of the substrate 811. The first area 311 may be formed corresponding to a lower surface of the base 210. A filter 610 may be disposed on the second area 312. The second area 312 may be formed corresponding to an edge of the opening. The second area 312 may be formed corresponding to an edge of the opening in which the image sensor 810 is disposed.

The first area 311 and the second area 312 may be formed as one region that is connected to each other. The first area 311 and the second area 312 may be formed to be spaced apart from each other. When the first area 311 and the second area 312 are formed to be spaced apart from each other, a hole may be formed in the plate 310 between the first area 311 and the second area 312 in addition to the opening. By forming the hole in the plate 310, the warping of the substrate can be minimized while reducing the overall weight of the camera module. When the first area 311 and the second area 312 are spaced apart from each other, an impact occurring in each region may not affect the other region.

Yet another embodiment, the plate 310 illustrated in FIG. 7, may comprise an opening through which an image sensor 810 passes, a first area 311 in which a first adhesive member 510 is disposed, a second area 312 in which a second adhesive member 520 is disposed, and a third region 313 connecting the first area 311 and the second area 312. The shapes of the first area 311, the second area 312, and the third region 313 may be variously modified. In the case of including a third region 313 connecting the first area 311 and the second area 312, an impact occurring in each region is transferred to another region and buffered, so that the amount of impact in each region can be reduced.

The lens driving device 100 illustrated in FIG. 3a and the bases 210 and 210A of the lens driving device 100A illustrated in FIG. 3b may be disposed in the substrate 811. At this time, the filter 610 may be fixed on the substrate 811 by an adhesive member. The filter 610 may be fixed on the plate 310 by an adhesive member. The filter 610 may be disposed in the bases 210 and 210A. A structure in which the filter 610 is fixed only by an adhesive member without a separate support structure may be referred to as a mold-less structure. The lens driving device 100B illustrated in FIG. 3c and the housing 1400 of the lens driving device 100C illustrated in FIG. 3d may be disposed in the substrate 811. At this time, the filter 610 may be fixed on the substrate 811 by an adhesive member. Although the base is not shown in FIGS. 3c and 3d, a base may be additionally disposed between the housing 1400 and the substrate 811. In this case, the filter 610 may be disposed inside the opening of the base.

The bases 210 and 210A may include an accommodating portion that accommodates a filter 610 therein. The filter 610 may be disposed spaced apart within the accommodating portion of the bases 210 and 210A. The accommodating portion of the bases 210 and 210A may mean a space in which the filter 610 is disposed. The inner side of the bases 210 and 210A may face the outer side surface of the filter 610.

The bases 210 and 210A may include an opening through which a lens barrel passes. The lens barrel may pass through the opening of the bases 210 and 210A depending on movement in an optical axis direction. When the lens barrel moves closest to the image sensor 810, it may pass through the opening of the bases 210 and 210A, and when the lens barrel moves farthest from the image sensor 810, it may not pass through the opening of the bases 210 and 210A.

According to another embodiment of the present invention illustrated in FIG. 4b, the filter 610 may be disposed in the plate 310. The second adhesive member 520 may be disposed between the filter 610 and the plate 310. The second adhesive member 520 may fix the filter 610 on the plate 310. The second adhesive member 520 may be disposed at the edge of the opening of the plate 310. The second adhesive member 520 may be disposed corresponding to the edge of the filter 610. The second adhesive member 520 may be disposed on a lower surface of the filter 610.

A filter 610 may be disposed on a second adhesive member 520 and a third adhesive member 530 may be disposed at an edge of the filter 610. The third adhesive member 530 may be disposed at the edge of the filter 610. The third adhesive member 530 may be disposed to encompass an upper surface and an outer side surface of the edge of the filter 610. The third adhesive member 530 may be disposed at two opposite surfaces of the edge of the filter 610. The third adhesive member 530 may be disposed at four surfaces of the edge of the filter 610. The third adhesive member 530 may be disposed to encompass an outer side surface of the second adhesive member 520. The second adhesive member 520 and the third adhesive member 530 may be disposed to form a step.

The filter 610 may include an upper surface 610a, a lower surface 610b being disposed at an opposite side of the upper surface 610a, and a side surface connecting the upper surface 610a and the lower surface 610b. The upper surface 610a, the lower surface 610b, and the side surface 610c of the filter 610 may be in contact with an adhesive member. A portion of the upper surface 610a, a portion of the lower surface 610b, and a portion of the side surface 610c of the filter 610 may be in contact with an adhesive member. The lower surface 610b of the filter 610 may be in contact with the second adhesive member 520. The upper surface 610a of the filter 610 may be in contact with the third adhesive member 530. The side surface 610c of the filter 610 can be in contact with at least one of the second adhesive member 520 and the third adhesive member 530. The third adhesive member 530 can be in contact with the upper surface 610a and the side surface 610c of the filter 610 and the side surface of the second adhesive member 520.

The second adhesive member 520 and the third adhesive member 530 may be an epoxy being cured by UV. The second adhesive member 520 and the third adhesive member 530 may have different shrinkage rates. The shrinkage rate of the second adhesive member 520 may be lower than the shrinkage rate of the third adhesive member 530. For example, the shrinkage rate of the second adhesive member 520 may be about 2% to 3%, and the shrinkage rate of the third adhesive member 530 may be 5 to 10% or more.

In order to fix the filter 610 to the plate 310, a second adhesive member 520 is first applied to the plate 310, and then the filter 610 is disposed, and then a third adhesive member 530 is secondarily applied to the edge of the filter 610 and cured. Since the third adhesive member 530 has a larger shrinkage rate than the second adhesive member 520, the third adhesive member 530 can provide tension F to the filter 610. Since shrinkage occurs during the curing process of the third adhesive member 530, tension F that pulls the filter 610 is generated, so that wave occurrence in the filter 610 can be minimized. The second adhesive member 520 can serve to support the filter 610, and the third adhesive member 530 can serve to prevent bending by generating tension in the filter 610. The second adhesive member 520 and the third adhesive member 530 can serve to fix the filter 610 in two stages.

A portion of the third adhesive member 530 being disposed in the filter 610 may be overlapped with the lens barrel in an optical axis direction. A portion of the third adhesive member 530 may face a lower surface of the lens barrel. In order to prevent the lens barrel and the filter 610 from coming into contact when the lens barrel moves in an optical axis direction, the third adhesive member 530 may be disposed to be higher than the filter 610. When the lens barrel moves in an optical axis direction, the lens barrel may first come into contact with the third adhesive member 530 than the filter 610.

A damper member (not shown) may be disposed in an area facing a lower surface of the lens barrel in the third adhesive member 530. The damper member may be formed by additionally applying epoxy after the third adhesive member 530 is cured. The damper member may be inserted into the third adhesive member 530 and cured together before the third adhesive member 530 is applied and cured. In this case, the damper member may be formed of a silicone material.

As the lens barrel moves adjacent to the image sensor 810, the damper member may be in contact with a lower surface of the lens barrel to absorb and buffer impact. The damper member may be disposed to be overlapped with the lens barrel in an optical axis direction. The damper member may be disposed to be overlapped with a lower surface of the lens barrel in an optical axis direction. The damper member may be disposed to be in contact with a lower surface of the lens barrel as the lens barrel moves in an optical axis direction within the opening of the bases 210 and 210A.

An upper surface of the damper member may be formed with a groove. The groove of the damper member 315 may be formed in a cross (+) shape on an upper surface. The groove of the damper member may facilitate attachment and detachment when in contact with a lower surface of the lens barrel. The groove of the damper member may serve to partition the upper surface of the damper member so that the damper member is easily attached and detached while securing an area in contact with a lower surface of the lens barrel. The groove of the damper member may be formed in various shapes, such as a circular shape or a star shape being recessed at the center of an upper surface.

The filter 610 may include a hole 611. The hole 611 of the filter 610 may be formed in an edge region. The hole 611 of the filter 610 may be formed in a region not being overlapped with the lens barrel in an optical axis direction. The hole 611 of the filter 610 may serve as a vent hole for discharging gas being generated during the curing process of the second adhesive member 520 and the third adhesive member 530. When the curing of the second adhesive member 520 and the third adhesive member 530 is completed, a hole adhesive member 540 may be disposed in the hole 611 of the filter 610 to block the hole 611.

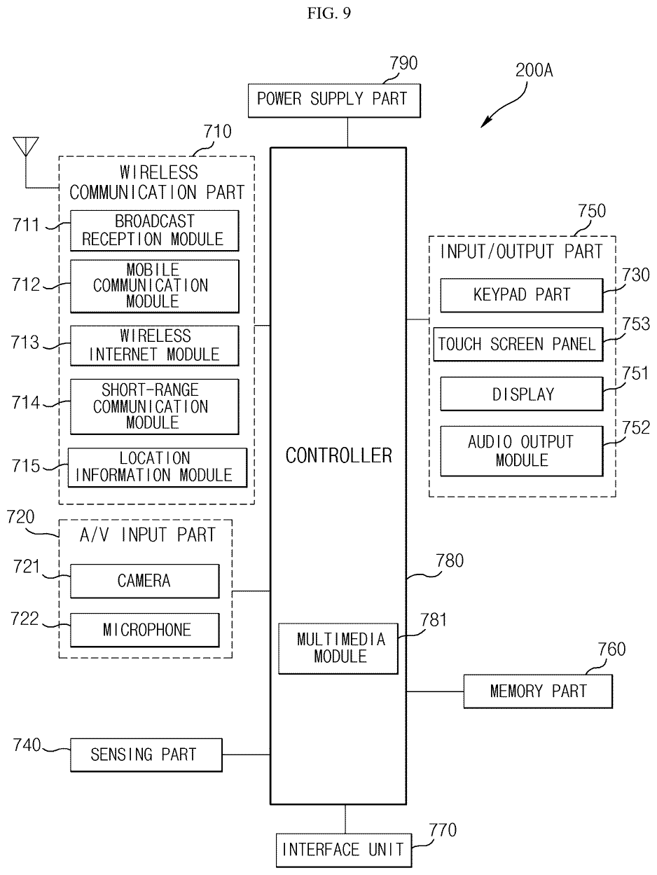

FIG. 8 is a perspective view of a portable terminal 200A according to an embodiment, and FIG. 9 is a configuration diagram of the portable terminal 200A illustrated in FIG. 8.

Referring to FIG. 8 and FIG. 9, a portable terminal 200A, hereinafter referred to as a “terminal”, may comprise: a body 850; a wireless communication unit 710; an A/V input unit 720; a sensing unit 740; an input/output unit 750; a memory unit 760; an interface unit 770; a control unit 780; and a power supply unit 790.

The body 850 illustrated in FIG. 8 is in the form of a bar, but is not limited thereto, and may be of various structures such as slide type, folder type, swing type, swivel type, and the like in which two or more sub-bodies are coupled to be relatively movable.

The body 850 may include a case (casing, housing, cover, and the like) forming an outer appearance. For example, the body 850 may be divided into a front case 851 and a rear case 852. Various electronic components of the terminal may be built into the space formed between the front case 851 and the rear case 852.

The wireless communication unit 710 may include one or more modules enabling wireless communication between the terminal 200A and a wireless communication system or between the terminal 200A and a network in which the terminal 200A is located. For example, the wireless communication unit 710 can be configured to include a broadcast reception module 711, a mobile communication module 712, a wireless Internet module 713, a short-range communication module 714, and a location information module 715.

The A/V input unit 720 is for audio signal or video signal input, and may include a camera 721, a microphone 722, and the like.

The camera 721 may include a camera device 200 according to an embodiment.

The sensing unit 740 may generate a sensing signal for controlling the operation of the terminal 200A by detecting the current state of the terminal 200A, such as the open/closed state of the terminal 200A, the location of the terminal 200A, whether or not there is a user contact, the direction of the terminal 200A, and the acceleration/deceleration of the terminal 200A. For example, when the terminal 200A is in the form of a slide phone, whether the slide phone is opened or closed may be detected. In addition, it is responsible for sensing functions related to whether or not power is supplied to the power supply unit 790, and whether or not the interface unit 770 is connected to an external device.

The input/output unit 750 is for generating an input or output related to visual, auditory, or tactile sense. The input/output unit 750 may generate input data for controlling the operation of the terminal 200A and, in addition, may display information processed by the terminal 200A.

The input/output unit 750 may include a keypad unit 730, a display module 751, a sound output module 752, and a touch screen panel 753. The keypad unit 730 may generate input data by keypad input.

The display module 751 may include a plurality of pixels whose color changes according to an electrical signal. For example, the display module 751 may include at least one among a liquid crystal display, a thin film transistor liquid crystal display, an organic light emitting diode, a flexible display, and a 3D display.

The audio output module 752 outputs audio data received from the wireless communication unit 710 in a call signal reception mode, a call mode, a recording mode, a voice recognition mode, or a broadcast reception mode, or may output audio data stored in the memory unit 760.

The touch screen panel 753 may convert a change in capacitance generated due to a user's touch on a specific area of the touch screen into an electrical input signal.

The memory unit 760 may store programs for processing and controlling the control unit 780, and may temporarily store an input/output data (for example, phone book, message, audio, still image, photo, video, and the like). For example, the memory unit 760 may store an image photographed by the camera 721, for example, a photo or video.

The interface unit 770 serves as a passage through which an external device connected to the terminal 200A is connected. The interface unit 770 receives data from an external device or receives power and transmits it to each component inside the terminal 200A, or transmits data inside the terminal 200A to an external device. For example, the interface unit 770 includes a wired/wireless headset port, an external charger port, a wired/wireless data port, a memory card port, a port connecting a device having an identification module, an audio input/output (I/O) port, a video input/output (I/O) port, an earphone port, and the like.

The control unit 780 may control overall operations of the terminal 200A. For example, the control unit 780 may perform related control and processing for voice calls, data communications, video calls, and the like.

The control unit 780 may include a multimedia module 781 for playing multimedia. The multimedia module 781 may be implemented inside the control unit 780 or may be implemented separately from the control unit 780.

The control unit 780 may perform pattern recognition processing capable of recognizing a handwriting input or a drawing input performed on the touch screen as a character and an image, respectively.

The power supply unit 790 may receive external power or internal power under the control of the control unit 780 to supply power required for operation of each component.

Those skilled in the art related to the present embodiment will understand that the above-described description can be implemented in a modified form without departing from the essential characteristics thereof. Therefore, the disclosed methods should be considered from an illustrative rather than a restrictive perspective. The scope of the present invention is indicated by the claims, not the above description, and all differences within the scope equivalent thereto should be interpreted as being included in the present invention.

1. A camera module comprising:
a substrate;
an image sensor disposed on the substrate;
a plate disposed on the substrate;
a base disposed on the plate;
a lens barrel disposed on the base;
a filter disposed on the plate;
a first adhesive member disposed between the plate and the base;
a second adhesive member disposed between the filter and the plate; and
a third adhesive member disposed on the edge of the filter,
wherein the third adhesive member is disposed to encompass an upper surface and an outer side surface of the edge of the filter.

2. The camera module according to claim 1,
wherein the third adhesive member overlaps the filter and the second adhesive member in an optical axis direction.

3. The camera module according to claim 1,
wherein the third adhesive member is disposed to encompass an outer side surface of the second adhesive member, and
wherein the filter is disposed between the second adhesive member and the third adhesive member.

4. The camera module according to claim 1,
wherein the shrinkage rate of the second adhesive member is smaller than the shrinkage rate of the third adhesive member.

5. The camera module according to claim 1,
wherein the filter comprises a hole, and
wherein a hole adhesive member is disposed in the hole of the filter.

6. The camera module according to claim 1,
wherein the plate comprises an opening through which the image sensor passes, a first area in which the first adhesive member is disposed, and a second area in which the second adhesive member is disposed, and
wherein the first area and the second area are disposed to be spaced apart from each other.

7. The camera module according to claim 6,
wherein the plate comprises a third area connecting the first area and the second area, and
wherein the opening is formed to be larger than the image sensor.

8. The camera module according to claim 6,
wherein the first area of the plate is formed to correspond to a lower surface of the base, and
wherein the second area of the plate is formed to correspond to an edge of the filter.

9. The camera module according to claim 6,
wherein the base comprises an opening through which the lens barrel passes and an accommodating portion for accommodating the filter therein, and
wherein the filter is disposed to be spaced apart inside the accommodating portion of the base.

10. A camera module comprising:
a substrate; an image sensor disposed on the substrate;
a plate disposed on the substrate;
a lens driving device comprising a base disposed on the plate, a housing disposed on the base, and a bobbin disposed inside the housing and movable in an optical axis direction;
a lens barrel disposed inside the bobbin; and
a filter disposed on the plate,
wherein the plate comprises a first area corresponding to a lower surface of the base and a second area corresponding to an edge of the filter,
wherein the filter is fixed to the plate by two adhesive members having different shrinkage rates,
wherein the two adhesive members having different shrinkage rates comprise a second adhesive member disposed between the filter and the plate and a third adhesive member disposed at an edge of the filter, and
wherein the shrinkage rate of the second adhesive member is smaller than the shrinkage rate of the third adhesive member.

11. The camera module according to claim 10,
wherein the second adhesive member, the third adhesive member, and the filter are overlapped with one another in an optical axis direction.

12. The camera module according to claim 10,
wherein the filter comprises a hole not overlapped with the lens barrel in an optical axis direction, and
wherein a hole adhesive member is disposed the hole of the filter.

13. The camera module according to claim 10,
wherein the first area is in which a first adhesive member is disposed,
wherein the second area is in which the second adhesive member is disposed, and
wherein the first area and the second area are disposed spaced apart from each other.

14. The camera module according to claim 10,
wherein the base comprises an opening through which the lens barrel passes and an accommodating portion for accommodating the filter therein, and
wherein the filter is disposed to be spaced apart inside the accommodating portion of the base.

15. A camera module comprising:
a substrate;
an image sensor disposed on the substrate;
a plate disposed on the substrate;
a lens driving device comprising a base disposed on the plate, a housing disposed on the base, and a bobbin disposed inside the housing and movable in an optical axis direction;
a lens barrel disposed inside the bobbin; and
a filter disposed on the plate,
wherein the filter is fixed to the plate by two adhesive members having different shrinkage rates,
wherein the two adhesive members having different shrinkage rates comprise a second adhesive member disposed between the filter and the plate and a third adhesive member disposed at an edge of the filter, and
wherein the shrinkage rate of the second adhesive member is smaller than the shrinkage rate of the third adhesive member.

16. The camera module according to claim 15,
wherein the third adhesive member is disposed to encompass an outer side surface of the second adhesive member, and
wherein the filter is disposed between the second adhesive member and the third adhesive member.

17. The camera module according to claim 15,
wherein the third adhesive member overlaps the filter and the second adhesive member in an optical axis direction.

18. The camera module according to claim 15,
wherein the base comprises an opening through which the lens barrel passes and an accommodating portion for accommodating the filter therein, and
wherein the filter is disposed to be spaced apart inside the accommodating portion of the base.

19. The camera module according to claim 15, comprising:
a first adhesive member disposed between the plate and the base,
wherein the plate comprises an opening through which the image sensor passes, a first area in which the first adhesive member is disposed, and a second area in which the second adhesive member is disposed, and
wherein the first area and the second area are disposed to be spaced apart from each other.

20. The camera module according to claim 15,
wherein the first area of the plate is formed to correspond to a lower surface of the base, and
wherein the second area of the plate is formed to correspond to an edge of the filter.
